(19) United States
(12) Patent Application Publication
(10) Pub. No.: US 2024/0418262 A1
(43) Pub. Date: Dec. 19, 2024

(54) PISTON RING

(71) Applicants: MAHLE Automotive Technologies (China) Co., Ltd., Shanghai (CN); MAHLE International GmbH, Stuttgart (DE)

(72) Inventor: Shaobo Zeng, Jiangsu (CN)

(21) Appl. No.: 18/745,965

(22) Filed: Jun. 17, 2024

(30) Foreign Application Priority Data
Jun. 16, 2023 (CN) 202321551658.2

(51) Int. Cl. F16J 9/20

(52) U.S. Cl. CPC F16J 9/20

(57) ABSTRACT

A piston ring used for being arranged in a ring groove of a piston of an engine and comprises an upper side face, a lower side face, an upper plane and a lower plane, the upper side face and the lower side face both incline to a datum plane, the datum plane is a plane perpendicular to the reciprocating motion direction of the piston, and the piston ring further comprises the upper plane and the lower plane. The inclination angles of the upper side face and the lower side face relative to the reference plane are different, and the upper plane and the lower plane cover different ranges in the radial direction of the piston ring.

### CROSS-REFERENCE TO RELATED APPLICATIONS

This application claims priority to Chinese Application No. CN 202321551658.2 filed on Jun. 16, 2023, the contents of which are hereby incorporated by reference in its entirety.

### TECHNICAL FIELD

The present application specifically relates to a piston ring for an engine, in the technical field of automotive parts.

### BACKGROUND

For an engine to achieve the objectives of high explosion pressure, long B10 life and low emissions (of NOx and particulates for example), key factors that need to be considered include initial blow-by volume, oil consumption, blow-by volume and oil consumption endurance.

As core components of an engine, the pistons and piston rings of the engine face a greater challenge in terms of endurance and reliability requirements. Low oil consumption and low blow-by volume with increased initial and endurance life can effectively ensure that it meets emissions requirements throughout its life cycle. The lower-side-face wear design of the piston's first ring groove and piston ring is an important step in lowering oil consumption endurance; a rational design is needed to increase its wear resistance at high engine explosion pressures (>220 bar).

FIG. 1 discloses a piston ring r1 in the prior art, configured to be disposed in the first ring groove of a piston. An upper side face 1 and a lower side face 2 of the piston ring r1 have symmetric angles of inclination, i.e. an upper inclination angle a1 and a lower inclination angle a2 are equal; an upper flat surface 3 and a lower flat surface 4 are formed at an outer periphery of the upper side face 1 and the lower side face 2, respectively, the upper flat surface 3 and lower flat surface 4 also being symmetric, i.e. the width L3 of the upper flat surface=the width L4 of the lower flat surface. To ensure that the ring has a positive-twist shape during motion, it is usually necessary to provide a large chamfer b at an inner side of the upper side face 1, and this involves complex process steps. Moreover, during operation, the lower side face 2 still experiences severe wear.

Chinese Utility Model CN215672475U has disclosed a piston ring with asymmetric trapezium faces, wherein the use of upper and lower trapezium faces which are asymmetric makes it unlikely that ring jamming due to carbon build-up will occur, as well as achieving good cylinder sealing, and also improves engine energy utilization and safety. However, it still leaves room for improvement.

### SUMMARY

An objective of the present application is to overcome or at least mitigate the shortcomings in the prior art mentioned above, by providing a structurally simple piston ring that is wear-resistant and highly reliable.

The present application provides a piston ring, configured to be disposed in a ring groove of a piston of an engine, and comprising: an upper side face configured to face towards a cylinder top face of the engine, and a lower side face facing away from the upper side face; with the piston ring fitted to the piston, the upper side face and the lower side face are both inclined relative to a reference plane, the reference plane being a plane perpendicular to a direction of reciprocation of the piston, wherein: the piston ring further comprises an upper flat surface and a lower flat surface, the upper flat surface being located at an outer periphery of the upper side face and configured to face towards the cylinder top face, and the lower flat surface being located at an outer periphery of the lower side face and facing away from the upper flat surface, the upper side face and the lower side face having different angles of inclination relative to the reference plane, and the upper flat surface and the lower flat surface having different extents of coverage in a radial direction of the piston ring.

In at least one embodiment, the angle of inclination of the upper side face relative to the reference plane is 2-3 times the angle of inclination of the lower side face relative to the reference plane.

In at least one embodiment, the angle of inclination of the lower side face relative to the reference plane is 2.5°-3.5°, and/or the angle of inclination of the upper side face relative to the reference plane is 7°-8°.

In at least one embodiment, the angle of inclination of the lower side face relative to the reference plane is 3°, and/or the angle of inclination of the upper side face relative to the reference plane is 7.5°.

In at least one embodiment, the upper side face and the lower side face enclose an angle of 10°-11°.

In at least one embodiment, an edge of the lower flat surface at a radial inner side has a larger radial dimension than an edge of the upper flat surface at the radial inner side.

In at least one embodiment, a distance from the edge of the lower flat surface at the radial inner side to an outer peripheral wall of the piston ring does not exceed 0.3 mm, and/or a distance from the edge of the upper flat surface at the radial inner side to the outer peripheral wall of the piston ring does not exceed 0.7 mm.

In at least one embodiment, the piston ring has a height of 2.5 mm-3.0 mm in an axial direction of the piston ring.

In at least one embodiment, no chamfer is provided at a radial inner side of the upper side face.

In at least one embodiment, the piston ring is configured to be disposed in a first ring groove of the piston that faces towards the cylinder top face.

The piston ring according to the present application is structurally simple and highly reliable, can produce a positive twist effect naturally, experiences little wear during operation, and can meet the requirements for high explosion pressure and long life of engines.

### BRIEF DESCRIPTION OF THE DRAWINGS

FIG. 1 is a schematic drawing of half of a cross section of a possible piston ring in the prior art.

FIG. 2 is a schematic drawing of half of a cross section of a piston ring according to an embodiment of the present application.

FIG. 3 compares schematic drawings of partial structures of a piston ring according to the present application and a piston ring in the prior art when fitted to an engine.

FIG. 4 shows wear experienced by a piston ring groove in an engine endurance test, corresponding to the use of the piston ring r1 of the existing design.

FIG. 5 shows wear experienced by a piston ring groove in an engine endurance test, corresponding to the use of a piston ring r10 provided in the present application.

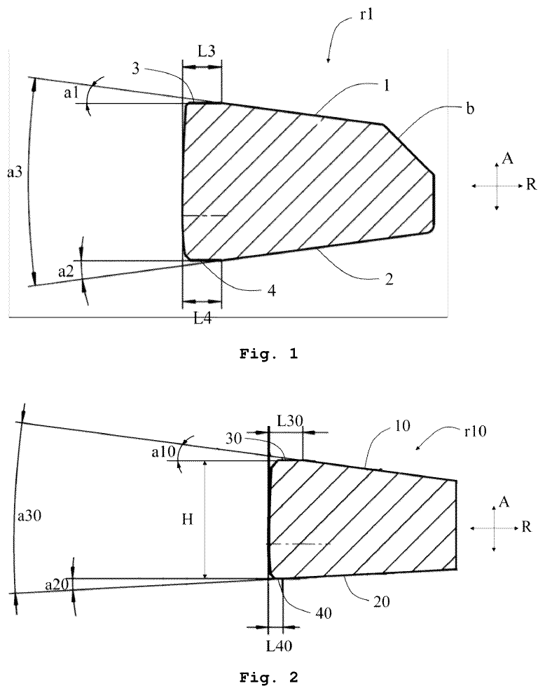

### DETAILED DESCRIPTION

Exemplary embodiments of the present application are described below with reference to the drawings. It should be understood that these specific descriptions are intended merely to teach those skilled in the art how to implement the present application, not to list all feasible forms of the present application exhaustively or limit the scope thereof.

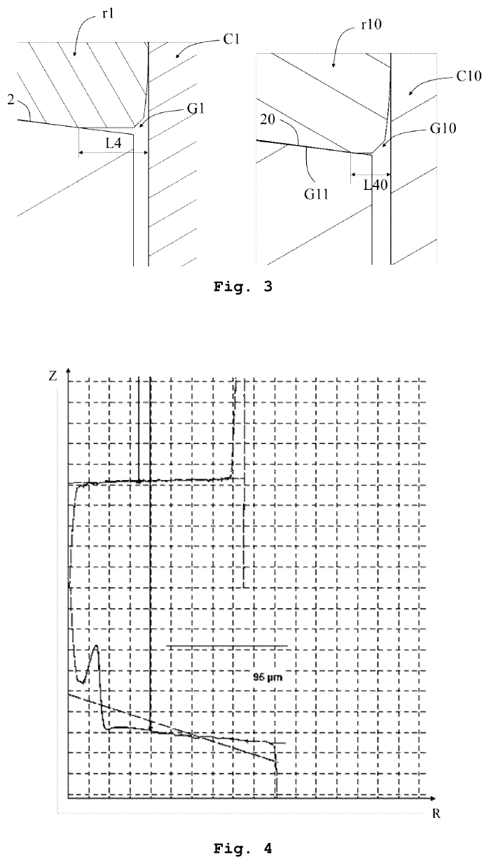

Referring to FIGS. 2 and 3, a piston ring r10 according to an embodiment of the present application is presented. In the figures, R denotes a radial direction of the piston ring, and A denotes an axial direction of the piston ring.

The piston ring r10 according to the present application is configured to be disposed in a first ring groove G10 of a piston, the first ring groove being configured to face towards a top face of an engine cylinder.

With the piston ring fitted to the piston, the direction in which the cylinder top face lies is defined as “above”, with “below” being opposite thereto. A plane perpendicular to the direction of reciprocation of the piston is defined as a reference plane.

The piston ring r10 comprises an annular upper side face 10 configured to face the cylinder top face and an annular lower side face 20 configured to face away from the cylinder top face, the upper side face 10 and the lower side face 20 both being inclined relative to the reference plane. The angle of inclination of the upper side face 10 relative to the reference plane is an upper inclination angle a10, and the angle of inclination of the lower side face 20 relative to the reference plane is a lower inclination angle a20. An angle enclosed by the upper side face 10 and the lower side face 20 is an overall angle a30.

In this embodiment, the upper inclination angle a10 is 2-3 times the lower inclination angle a20. Such an angular difference enables the piston ring r10 to produce a positive twist effect naturally during operation, without the need for a chamfer at the inner side, thus enabling a reduction in the number of machining steps and lowering the manufacturing cost.

Specifically, the lower inclination angle a20 is about 2.5°-3.5°, and the upper inclination angle a10 is about 7°-8°. Optionally, in one embodiment, the upper inclination angle a10 is about 7.5°, and the lower inclination angle a20 is about 3°. Optionally, the value of the overall angle a30 is 10°-11°.

An annular upper flat surface 30 is formed at an outer periphery of the upper side face 10, and an annular lower flat surface 40 is formed at an outer periphery of the lower side face 20. The upper flat surface 30 and the lower flat surface 40 are both parallel to the reference plane. The upper side face 10 and the upper flat surface 30 are connected to each other directly, and the lower side face 20 and the lower flat surface 40 are connected to each other directly.

The distance between an inner peripheral edge of the upper flat surface 30 and an outer peripheral wall of the piston ring r10 (i.e. a cylinder wall of the cylinder) is an upper flat surface width L30, and the distance between an inner peripheral edge of the lower flat surface 40 and an outer peripheral wall of the piston ring r10 (i.e. the cylinder wall of the cylinder) is a lower flat surface width L40.

The lower flat surface width L40 is less than the upper flat surface width L30. Optionally, the lower flat surface width L40 does not exceed 0.3 mm, and the upper flat surface width L30 does not exceed 0.7 mm. Optionally, the distance between the upper flat surface 30 and the lower flat surface 40, i.e. a piston ring height H, is 2.5 mm-3.0 mm.

Referring to FIG. 3, this compares the piston ring r10 provided in the present application with the piston ring r1 of the existing design, and in particular shows the difference between the two piston rings when their lower flat surface widths L40 are of different sizes. It can be seen from the figure that the reduced lower flat surface width L40 enables the lower side face 20 to have a larger area in contact with a groove bottom face G11 of the first ring groove G10. The increase in the contact area can reduce the pressure experienced by the groove bottom face G11, so that the groove bottom face G11 is not easily worn.

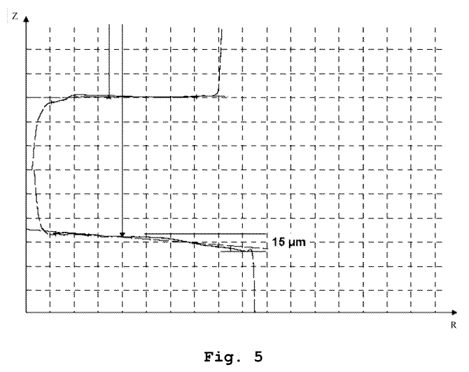

FIGS. 4 and 5 show wear experienced by a piston ring groove in an engine endurance test, corresponding to the use of the piston ring r1 of the existing design and the piston ring r10 provided in the present application, respectively. In the figures, the vertical axis represents the height direction of the ring groove, and the horizontal axis represents the diameter direction. It can be seen from FIG. 4 that when the piston ring r1 of the existing design is used, after an endurance test under given operating conditions, the amount of wear to the groove bottom face of the ring groove, which is configured to contact the lower side face 2 of the piston ring r1, reaches 95 μm; under the same operating conditions, using the piston ring r10 in FIG. 5, the amount of wear to the groove bottom face of the ring groove, which is configured to contact the lower side face 20 of the piston ring r10, is only 15 μm, i.e. the amount of wear to the groove bottom face is reduced by more than 80%. Since the amount of wear to the ring groove is an important parameter for judging whether the engine requires a major overhaul, the use of the piston ring r10 according to the present application can significantly increase the engine's endurance time or major overhaul period.

The present application has at least one of the following advantages:
(i) The angles of inclination of the upper side face 10 and lower side face 20 relative to the reference plane are different, the upper inclination angle a10 being 2-3 times the lower inclination angle a20, thus enabling the piston ring r10 to produce a positive twist effect naturally without the need for a chamfer at the inner side, reducing the number of machining steps and lowering the manufacturing cost.
(ii) The upper flat surface 30 and the lower flat surface 40 are asymmetric, the lower flat surface width L40 being less than the upper flat surface width L30. Such an asymmetric design increases the area of contact between the ring and the ring groove, significantly reducing the maximum contact stress of the ring and the ring groove; the reduction in stress exceeds 20%, thus enabling a significant reduction in wear to the ring and the ring groove, improving endurance, and meeting the requirements for high explosion pressure and long life of the engine.
(iii) When the ring height is low (e.g. no more than 3 mm), the piston ring design provided in the present application is better suited to the requirement for high explosion pressure.

Of course, the present application is not limited to the embodiments above; those skilled in the art can make various changes to the above-described embodiments of the present application based on the teaching of the present application, without departing from the scope thereof.

1. A piston ring, comprising:
an upper side face configured to face towards a cylinder top face of an engine, and a lower side face facing away from the upper side face, wherein
the upper side face and the lower side face are both inclined relative to a reference plane, the reference plane being a plane perpendicular to a direction of reciprocation of a piston; and
an upper flat surface and a lower flat surface, the upper flat surface being located at an outer periphery of the upper side face and configured to face towards the cylinder top face, and the lower flat surface being located at an outer periphery of the lower side face and facing away from the upper flat surface, wherein the upper side face and the lower side face have different angles of inclination relative to the reference plane, and the upper flat surface and the lower flat surface have different extents of coverage in a radial direction of the piston ring.

2. The piston ring according to claim 1, wherein the angle of inclination of the upper side face relative to the reference plane is 2-3 times the angle of inclination of the lower side face relative to the reference plane.

3. The piston ring according to claim 2, wherein the angle of inclination of the lower side face relative to the reference plane is 2.5°-3.5°, and/or the angle of inclination of the upper side face relative to the reference plane is 7°-8°.

4. The piston ring according to claim 2, wherein the angle of inclination of the lower side face relative to the reference plane is 3°, and/or the angle of inclination of the upper side face relative to the reference plane is 7.5°.

5. The piston ring according to claim 1, wherein the upper side face and the lower side face enclose an angle of 10°-11°.

6. The piston ring according to claim 1, wherein an edge of the lower flat surface at a radial inner side has a larger radial dimension than an edge of the upper flat surface at the radial inner side.

7. The piston ring according to claim 6, wherein a distance from the edge of the lower flat surface at the radial inner side to an outer peripheral wall of the piston ring does not exceed 0.3 mm, and/or a distance from the edge of the upper flat surface at the radial inner side to the outer peripheral wall of the piston ring does not exceed 0.7 mm.

8. The piston ring according to claim 7, wherein the piston ring has a height of 2.5 mm-3.0 mm in an axial direction of the piston ring.

9. The piston ring according to claim 1, wherein no chamfer is provided at a radial inner side of the upper side face.

10. The piston ring according to claim 9, wherein the piston ring is configured to be disposed in a first ring groove of a piston that faces towards the cylinder top face.

11. A piston ring, comprising:
an upper side face configured to face towards a cylinder top face of an engine, and a lower side face facing away from the upper side face, wherein the upper side face and the lower side face are both inclined relative to a reference plane, the reference plane being a plane perpendicular to a direction of reciprocation of a piston;
an upper flat surface, the upper flat surface being located at an outer periphery of the upper side face and configured to face towards the cylinder top face; and
a lower flat surface, the lower flat surface being located at an outer periphery of the lower side face and facing away from the upper flat surface, wherein the upper side face and the lower side face have different angles of inclination relative to the reference plane.

12. The piston ring according to claim 11, wherein the angle of inclination of the upper side face relative to the reference plane is 2-3 times the angle of inclination of the lower side face relative to the reference plane.

13. The piston ring according to claim 12, wherein the angle of inclination of the lower side face relative to the reference plane is 2.5°-3.5°, and the angle of inclination of the upper side face relative to the reference plane is 7°-8°.

14. The piston ring according to claim 12, wherein the angle of inclination of the lower side face relative to the reference plane is 3°, and the angle of inclination of the upper side face relative to the reference plane is 7.5°.

15. The piston ring according to claim 11, wherein the upper side face and the lower side face enclose an angle of 10°-11°.

16. The piston ring according to claim 11, wherein an edge of the lower flat surface at a radial inner side has a larger radial dimension than an edge of the upper flat surface at the radial inner side.

17. The piston ring according to claim 16, wherein a distance from the edge of the lower flat surface at the radial inner side to an outer peripheral wall of the piston ring does not exceed 0.3 mm, and a distance from the edge of the upper flat surface at the radial inner side to the outer peripheral wall of the piston ring does not exceed 0.7 mm.

18. The piston ring according to claim 17, wherein the piston ring has a height of 2.5 mm-3.0 mm in an axial direction of the piston ring.

19. The piston ring according to claim 11, wherein no chamfer is provided at a radial inner side of the upper side face.

20. The piston ring according to claim 19, wherein the piston ring is configured to be disposed in a first ring groove of a piston that faces towards the cylinder top face.
